(19) United States
(12) Patent Application Publication
(10) Pub. No.: US 2005/0184674 A1
(43) Pub. Date: Aug. 25, 2005

(54) Flexible linear lighting system

(76) Inventors: Stephen Kaler, Jupiter, FL (US); Ricky L. Lynch, Lancaster, TX (US); W. Clay Reeves, Dallas, TX (US); Frank Malanga, Jackson, NJ (US)

Correspondence Address: KAPLAN & GILMAN , L.L.P., 900 ROUTE 9 NORTH, WOODBRIDGE, NJ, 07095, US

(21) Appl. No.: 11/038,016

(22) Filed: Jan. 18, 2005

Related U.S. Application Data
(60) Provisional application No. 60/538,848, filed on Jan. 23, 2004.

(51) Int. Cl. G09G 3/10

(52) U.S. Cl. 315/169.3

(57) ABSTRACT

A system comprising a flexible linear EL cable, power source and power management module is disclosed. A power management module according to the present invention permits the flexible linear light cable to be powered or charged through a single connection. Employing a power management module in accordance with the present invention external DC power, via an external battery or 12V AC adapter, can be utilized without causing damage to an internal battery. The system is adapted to be portable for long lengths of reinforced EL wire for use virtually anywhere such as but not limited in shipboard firefighting.

This application claims the benefit of U.S. Provisional Patent Application No. 60/538,848, entitled “Flexible Linear Lighting System,” filed Jan. 23, 2004, the entire disclosure of which is hereby incorporated by reference.

### TECHNICAL FIELD

This invention relates to linear lighting devices, and more particularly, to a flexible linear lighting system.

### BACKGROUND OF THE INVENTION

Safety and construction professionals often encounter dangerous conditions resulting from among other things a lack of light. For example, firefighters are constantly forced to operate in smoke-filled, darkened conditions. Highway construction workers, police and safety personnel often must work during nighttime hours, often without the benefit of sufficient light. Scuba divers and workers aboard ships also operate in darkened conditions. As a result, a need exists for light lines to demarcate paths to safety as well as crime scenes, rescue sites and the like. A suitable choice for such a light string is electroluminescent (EL) wire. Such wires are described in for example U.S. Pat. Nos. 3,819,973 and 5,869,930. In order to be useful to safety personnel, EL wire must be reinforced, highly portable and usable and include the ability to easily adapt to different power sources.

U.S. Pat. No. 6,758,314 discloses a light reel system for holding EL wire employing a self-contained battery and inverter However, this reel is not suitable for applications requiring continuous extended periods of use, such as use beyond the length of time the internal battery can hold a charge, because an external power supply cannot be employed. The only means of powering the device of this patent is an external battery charger via a 2-pin connector, precluding use of an external power supply.

It is therefore an object of the invention to provide a portable flexible linear lighting system that can be employed in conjunction with an external power supply.

It is a further object of the invention to provide an EL lighting system that is easily and reliably adapted to an external power supply.

It is still another object of the invention to provide a flexible linear lighting system having reinforced EL wire.

It is yet a further object of the invention to provide a reel for an EL lighting system that is easily and reliably adapted to an external power supply using generally available power cords such as extension cords.

It is a further object of the present invention to provide a device suitable for conveniently carrying long lengths of EL cable.

It is a further object of the present invention to provide an EL lighting power system adapted for use in conjunction with fire hoses.

The foregoing and other objects of the present invention will be clear upon review of the following description and drawings.

### SUMMARY OF THE INVENTION

The above and other problems of the prior art are overcome in accordance with the present invention which relates to a flexible linear light system suitable for use in firefighting, rescue, hazardous material, law enforcement and other applications to define work zones, hazard zones, paths, and the like. A system comprising a flexible linear EL cable, power source and power management module is disclosed. The EL cable employed in the system is reinforced to resist damage and deterioration from heat, chemical and physical stress. A power management module according to the present invention permits the flexible linear light cable to be powered or charged through a single connection. Employing a power management module in accordance with the present invention external DC power, via an external battery or 12V AC adapter, can be utilized without causing damage to an internal battery. The system is adapted to be portable, via reel or bag as described herein, for long lengths of reinforced EL wire for use virtually anywhere such as but not limited in shipboard firefighting. In a preferred embodiment the system is adapted for use with a fire hose.

### BRIEF DESCRIPTION OF THE DRAWINGS

FIG. 1 depicts a side cross section of a preferred embodiment of a system in accordance with an embodiment of the present invention;

FIG. 2 depicts one embodiment of a schematic of a power control module of a system in accordance with an embodiment of the present invention;

FIG. 3 depicts a system in accordance with one embodiment of the present invention;

FIG. 4 depicts a front view of one embodiment of the present invention;

FIG. 4A depicts a side view of one embodiment of the present invention;

FIG. 4B depicts an exploded side perspective view of one embodiment of the present invention;

FIG. 4C depicts a cross-section of a perspective view of one embodiment of the present invention;

FIG. 5A depicts a bottom view of one embodiment of the present invention;

FIG. 5B depicts a side-perspective view of one embodiment of the present invention;

FIG. 5C depicts a cross-sectional side view of one embodiment of the present invention;

FIG. 5D depicts a perspective view of one embodiment of the present invention;

FIG. 5E depicts a perspective view of one embodiment of the present invention;

FIG. 5F depicts a front view of one embodiment of the present invention;

FIG. 6 depicts a perspective view of a fire hose sleeve in accordance with one embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

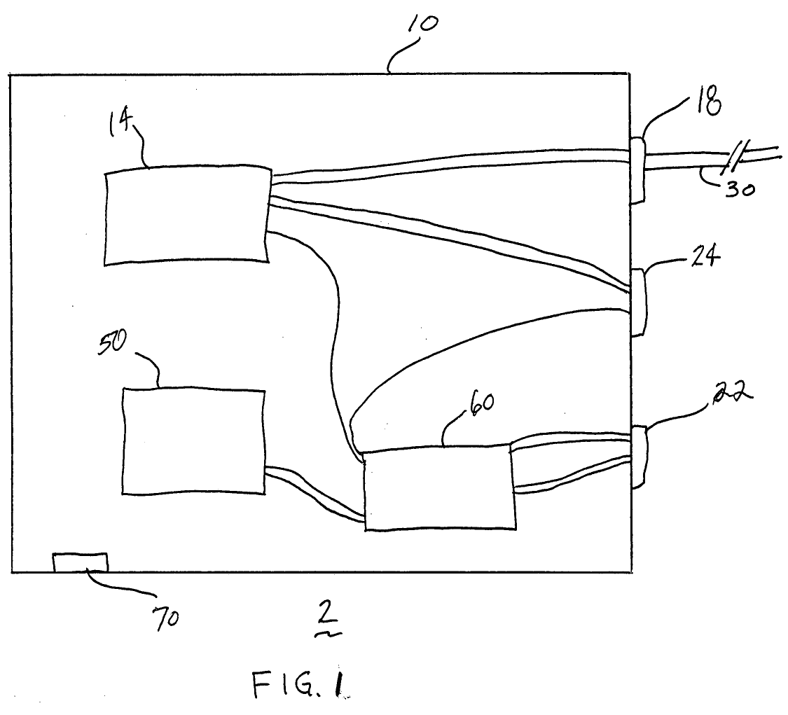

Now referring to FIG. 1 in a preferred embodiment of a system 2 in accordance with the present invention comprises a housing 10 comprising a battery 50, a power control module 60, inverter 14, AC output connection 18, input connection 22, and on/off switch 24 for controlling the flow of power to EL cable 30. System 2 may further comprise a battery charger disposed in said housing.

Suitable EL wires to be used in EL cables 30 are commercially available from Elam Electroluminescent Inds. of Israel. Such wires may be single or double core EL wires ranging from about 1.2 mm to 5 mm in diameter. In a preferred embodiment double-core wires are employed. The wires, and hence, cables 30, can be provided in a variety of colors. The EL wire is augmented to commercial grade EL cable 30 preferably by a cable extrusion and cable assembly process known to those skilled in the art by which layers of material, preferably plastic, are added to the EL wire to create EL cable 30. Such extrusion processes are provided for example by Intercon 1 of Baxter, Minn. Cable 30 may comprise a plurality of lengths coupled together such as by soldering or employing a coupling to increase the length of the cable 30.

Housing 10 is any suitable housing for containing electronics. Housing 10 may comprise packing material. Suitable housings 10 are commercially available from Polycase of Avon, Ohio or Simco of Avon Park, Fla. Connections 16 and 18 are commercially available from Digikey Corp. of Thief River Falls, Minn. or Mouser Electronics of Mansfield, Tex. Housing 10 may further comprise a switch 24 for controlling the flow of power to EL cable 30. Housing 10 may further comprise a breather valve 70 to control pressure differentials between the interior and exterior of the housing to reduce the risk of compartment explosion due to battery leakage or malfunction. Suitable breather valves are commercially available from Aerodyne Controls of Ronkonkoma, N.Y. In a preferred embodiment housing 10 comprises a plurality of electronic elements as set forth hereinabove, i.e., multiple inverters 14, internal batteries 50, power management modules 60 and multiple inputs, outputs and switches to accommodate multiple EL cables 30.

Inverter 14 inverts DC to AC to provide power to EL cable 30. Suitable inverters are commercially available from MetroMark, Inc. of Minnetonka, Minn. or Densitron Corp. of Santa Fe Springs, Calif.

An external battery charger may be employed with the system 2. Suitable battery chargers are commercially available from House of Batteries, Huntington Beach, Calif. or Plainview Batteries Inc. of Plainview, Calif. Alternatively, a 12V AC adapter may be employed. Battery 50 preferably has a minimum of about 12 volts, most preferably a 13.2 volt 11 cell battery pack. Suitable batteries are commercially available from Cell Con Inc. of Exton, Pa. or Plainview Batteries Inc. of Plainview, Calif. Power may be supplied via a 12 volt AC adapter. Power is preferably in the range of about 40V/800 Hz to about 220V/4000 Hz and most preferably in the range of about 40V/1300 Hz to about 180V/1600 Hz.

Power control module 60 disables the inverter 14 when an external power supply is attached, thus preventing the inverter 14 from drawing current while the battery 50 is being charged even if the switch 24 is in the “on” position. Input connection 22 preferably comprises a four-pin connector, male or female, connected via wires to power control module 60 as shown in FIG. 1. In one embodiment a positive and negative pin are connected to the power module 60 for external battery charger input to charge internal battery 50. A second set of positive and negative pins in the four-pin connector are provided for external DC power input via an external battery or 12 volt adapter to power module 60, which directs the external DC power directly to inverter 14 to power the EL cable 30 after internal battery 50 has drained. By utilizing the power module 60 the correct power inputs (battery charge current or DC power current) are directed appropriately. Without the power module 60 and the four-pin connector combination external DC power cannot be utilized without causing damage to the internal battery 50 or risk of battery leakage or explosion.

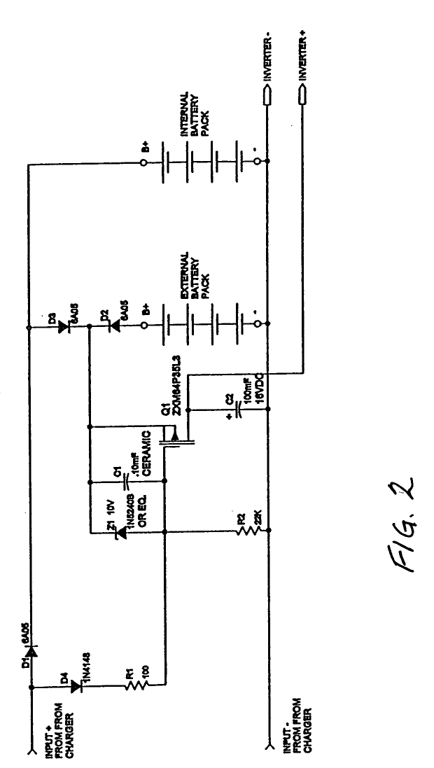

Now referring to FIG. 2 a preferred embodiment of a schematic of power control module 60 is disclosed. In this embodiment the control module 60 permits an external battery, not shown, to be attached. The circuit prevents an internal battery 50 from drawing current from an external battery.

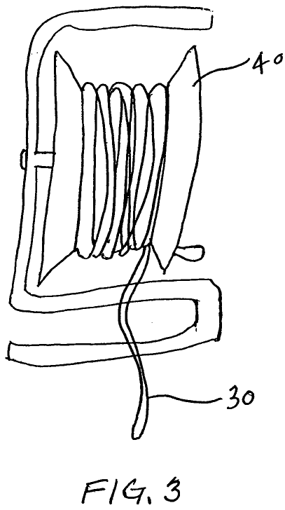

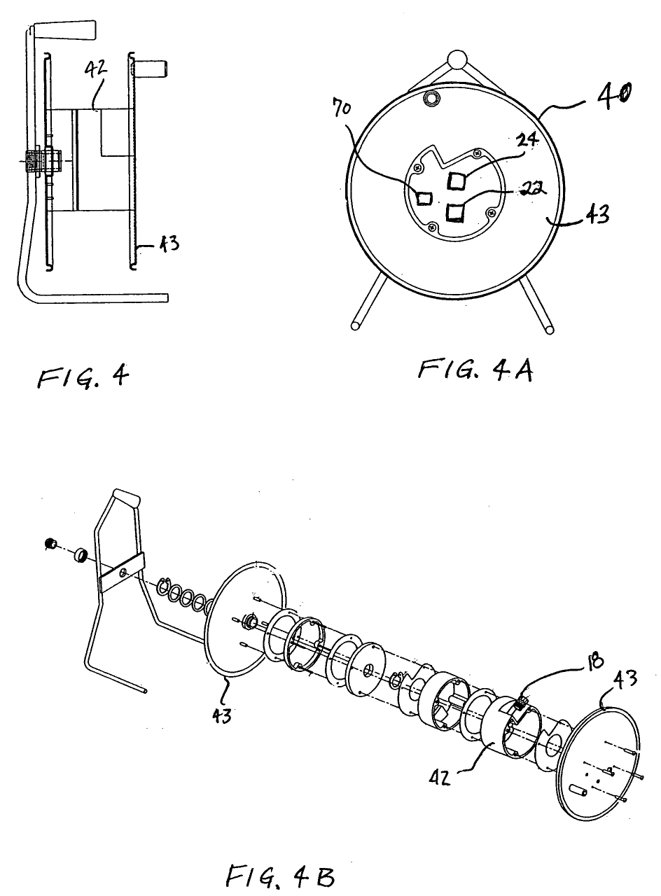

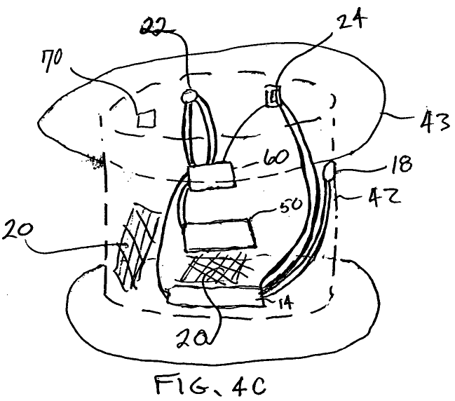

Now referring to FIGS. 3 and 4 through 4C, in a preferred embodiment housing 10 comprises a reel 40 to which cable 30 is connectable and wound upon. The necessary electronics including inverter 14, battery 50 and power management module 60 are preferably contained in reel drum 42. Now referring to FIG. 4C, in a most preferred embodiment all the electronic components contemplated herein and shown in FIG. 1 are contained in reel drum 42. Connections at 18 and 22, preferably watertight, are provided exterior to drum 42 such as on the exterior surface of drum 42 or on the exterior of a flange 43 extending from drum 42. A breather valve 70 as described hereinabove is preferably provided exterior to drum 42, such as on the exterior surface of drum 42 or on the exterior of a flange 43 extending from drum 42. A switch 24 is preferably provided exterior to drum 42, such as on the exterior surface of drum 42 or on the exterior of a flange 43 extending from drum 42.

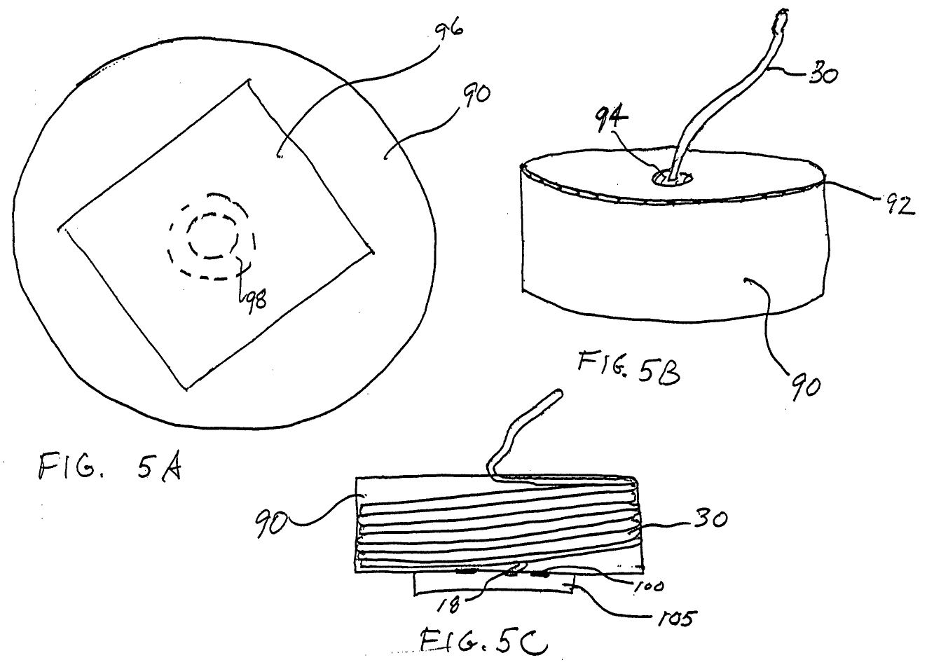

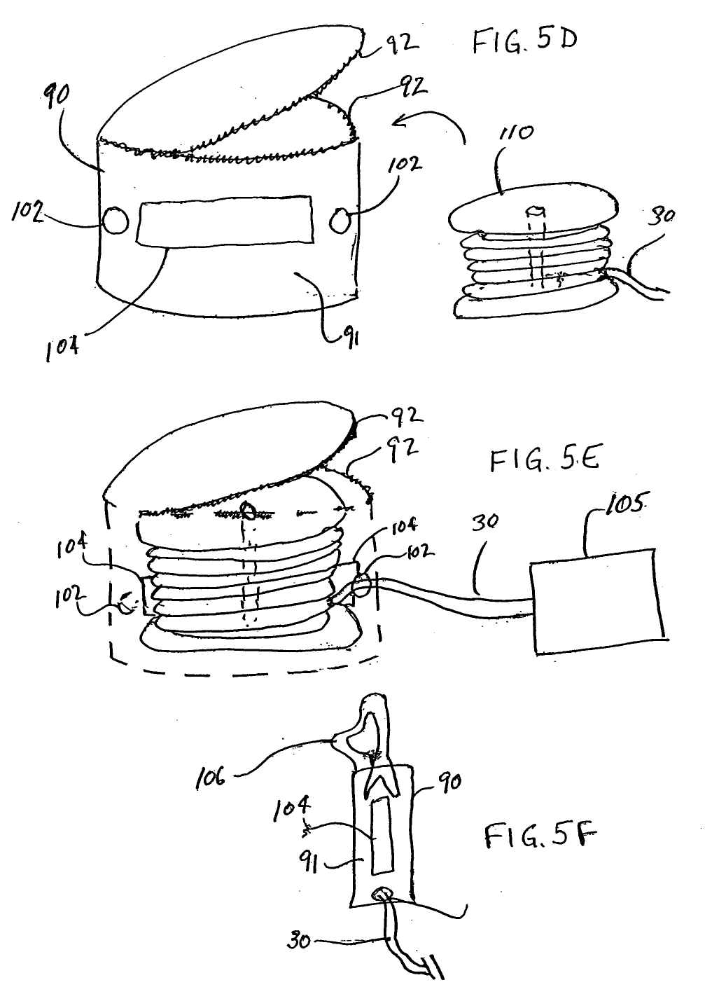

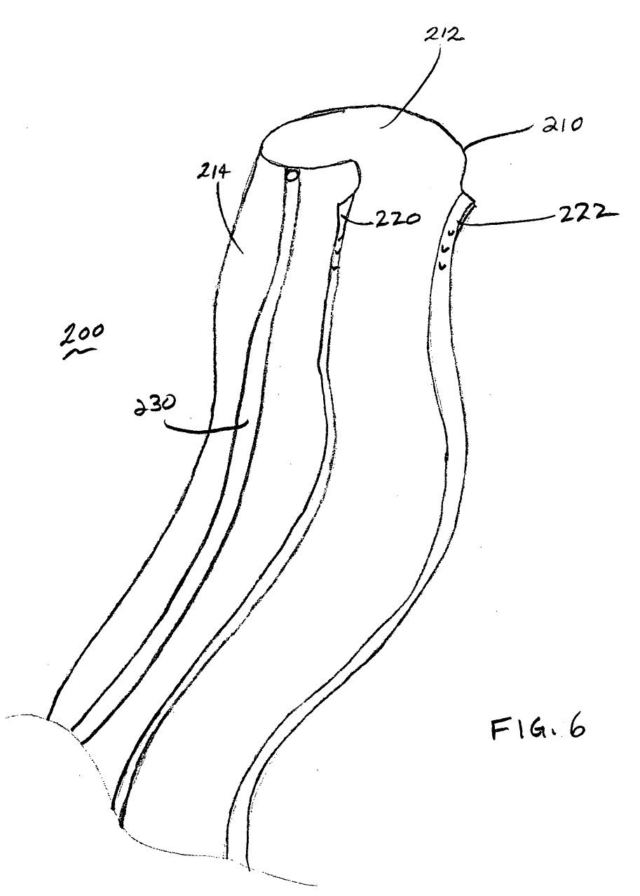

Now referring to FIGS. 5A-5F, in a preferred embodiment system 2 further comprises a bag 90 for containing EL cable 30. Bag 90 preferably comprises an openable closure means 92 such as but not limited to a zippered closure, Velcro closure or the like to permit secure placement of the EL cable 30 in the bag 90. Bag 90 further comprises openings 94 and 98 at the top and bottom, respectively, of the bag 90 to permit one end of the EL cable 30 to be deployed and the other end to be attached to a power supply. In one embodiment shown in FIG. 5A bag 90 further comprises a pouch 96 into which a power supply 105, such as but not limited to housing 10 as described hereinabove or a battery, can be secured. An end of EL cable 30 is fed through opening 98 to a power supply 105 which is secured to bag 90. EL cable 30 is coiled in bag 90 and is fed out opening 94 for deployment. In an alternate embodiment, now referring to FIG. 5C, bag 90 comprises an attachment device such as but not limited to clips or Velcro fasteners 100 for attaching said power supply 105 to said bag 90. Complementary clips or Velcro fasteners may be provided on said power supply 105. The bag 90 permits portable use of the system such as but not limited to shipboard firefighting applications. The bag can be used in conjunction with reel 40. This embodiment enables firefighters and safety workers to keep the power supply 105 and/or housing 10 out of the zone of danger. The bag 90 is carried to the scene, placed on the ground, switched on and the EL cable 30 is simply pulled out of the bag 90 for immediate use. The bag 90 is preferably provided in various sizes to accommodate various lengths of cable 30. Bag 90 preferably further comprises at least one strap (see FIG. 5F) to permit manageable handling and transport of said bag 90 regardless of the length of cable 30 contained therein.

Now referring to FIGS. 5D-5F, in a preferred embodiment bag 90 comprises at least one opening 102 formed in a side wall 91 of said bag 90 and at least one window 104 formed in said side wall 91. A spool 110 may be provided upon which EL cable 30 is wound. Now referring to FIG. 6E spool 110 is placed in bag 90 and one end of EL cable 30 is fed through an opening 102 to power supply 10. The other end of EL cable 30 is disposed on spool 110 and is preferably fixed to the spool 110 so as not to become disengaged as the EL cable 30 is spun off spool 110. Light from EL cable 30 is visible through window 104 when power is supplied to EL cable 30. In this embodiment a power supply 105 is preferably stationary and bag 90 can be carried by a firefighter, rescue worker or the like into a zone of danger, cable 30 being paid off the spool 110 as the worker advances. Bag 90 may comprise any suitable material and preferably is plastic lined to provide a low friction surface for movement of EL cable 30 as it comes off spool 110. In a preferred embodiment a shoulder strap 106 is provided on bag 90 for easy carrying by a user. A plurality of openings 102 are provided for the sake of versatility, such as to provide a user the ability to carry bag 90 over either shoulder and easily pay out EL cable 30. Bag 90 may further comprise a reflective material disposed on its exterior or interior for purposes of enhanced visibility. Bag 90 may further comprise a mandrel or spindle (not shown) for mounting spool 110.

In a further embodiment the system 2 comprises a length of EL cable 30 disposed on the exterior of a fire hose (not shown). Now referring to FIG. 6, in one embodiment a sleeve 200 is provided that covers at least in part an existing fire hose is provided. Such sleeves are commercially available from Can Man LLC of Manalapan, N.J. In a preferred embodiment the sleeve 200 may optionally cover the hose couplings (not shown).

The sleeve 200 comprises a sheet 210 preferably thin, fabricated of any suitable material such as but not limited to natural or synthetic woven or nonwoven fabric, plastic or the like. The sleeve 200 is preferably in the form of a lightweight sheet 210 having an inner surface 212 and an outer surface 214, fastening means 220 such as but not limited to Velcro, hooks, snaps, buttons or the like disposed along one edge thereof and complementary fastening means 222 along at least one other edge thereof so that said sheet may be wrapped securely around a hose, and tubing 230. In a preferred embodiment the fastening means 220 and 222 comprise a Velcro seam that secures the sleeve 200 to the hose. In a most preferred embodiment the sleeve 200 is adaptable to cover hoses of various sizes. In one embodiment the sheet forming the sleeve 200 is provided at least in part on one side with Velcro loop and provided at least in part on the other side with Velcro lock fastening means. In a most preferred embodiment the sleeve 200 comprises about 12.5 inch (width) by 200 foot (length) cotton duck The sleeve 200 may further comprise indicia such as for example reflective directional arrows to assist in guiding the firefighters; name and/or number of engine company and the like. Alternatively, the sleeve 200 may be specially designed, manufactured and/or fitted to cover various size hose lines including but not limited to 1½, 1¾, 2, 2½ and 3″ hose lines.

Tubing 230 is provided as conduit for EL cable 30. Tubing 230 is disposed on the exterior of said sleeve 200 and attached thereto by any suitable means such as but not limited to stitching, webbing, adhesive and the like. Tubing 230 is preferably translucent or transparent and formed of any suitable flexible material such as but not limited to vinyl, stainless steel mesh and the like. In a most preferred embodiment tubing is a 400-foot length of 1¾ clear vinyl.

Alternatively EL cable is adhered directly to said sleeve such as by adhesive, stitching or the like.

In a most preferred embodiment the sleeve with the EL cable 30 remains mounted on a fire hose and is only removed for repair or maintenance.

In a preferred embodiment the system 2 is adapted to be used with or without a fire hose and further comprises a system preferably hard wired to a DC power source or generator located on a fire truck. Preferably said system is connected to remaining components power control module 60, inverter 14, AC output 18, input 22, on/off switch 24 mounted in the pump panel of a fire truck.

While the preferred embodiments have been described and illustrated it will be understood that changes in details and obvious undisclosed variations might be made without departing from the spirit and principle of the invention and therefore the scope of the invention is not to be construed as limited to the preferred embodiment.

1. A flexible linear lighting system comprising at least one length of electroluminescent cable, at least one inverter and at least one power management module.

2. The system according to claim 1 further comprising a housing containing said at least one inverter and at least one power management module.

3. The system according to claim 1 said housing comprising a reel.

4. The system according to claim 1 said electroluminescent cable extending from an outside surface of a fire hose.

5. The system according to claim 1 further comprising a bag adapted to contain at least a portion of the length of said electroluminescent cable.

6. The system according to claim 1 wherein said electroluminescent cable is reinforced.

7. A flexible linear lighting system comprising at least one length of electroluminescent cable, a housing comprising at least one inverter and a bag adapted to contain at least a portion of the length of said electroluminescent cable.

8. The system according to claim 7 further comprising a housing containing said at least one inverter.

9. The system according to claim 7 further comprising at least one power management module.

10. The system according to claim 7, said housing comprising a reel.

11. The system according to claim 7 said bag comprising a means for holding a power supply.

12. The system according to claim 7 said bag comprising openable closure means.

13. The system according to claim 7 said bag comprising at least one cable deployment opening.

14. The system according to claim 7 said bag comprising a window formed thereon.

15. The system according to claim 7 further comprising a spool.

16. The system according to claim 7 said bag comprising at least one opening adapted to permit connection of said electroluminescent cable to a power supply.

17. The system according to claim 7, said bag comprising a low-friction interior material.

18. The system according to claim 7 comprising a strap extending from said bag.

19. The system according to claim 7 said bag comprising a reflective material disposed on at least an interior or interior surface thereof.

20. The system according to claim 7 said bag comprising a spool-mounting spindle.

21. A bag comprising at least one electroluminescent cable deployment opening.

22. The invention according to claim 21 further comprising openable closure means.

23. The invention according to claim 21 further comprising means for holding a power supply.
